(19) United States
(12) Patent Application Publication
(10) Pub. No.: US 2012/0000970 A1
(43) Pub. Date: Jan. 5, 2012

(54) GIFT WRAP WITH TAPE

(76) Inventor: Erin Johnson, Medina, OH (US)

(21) Appl. No.: 13/173,623

(22) Filed: Jun. 30, 2011

Related U.S. Application Data
(60) Provisional application No. 61/359,848, filed on Jun. 30, 2010.

(51) Int. Cl. B65D 65/38; G09F 3/10; G09F 3/02; B32B 33/00

(52) U.S. Cl. 229/87.19; 428/42.3; 40/638; 40/674

(57) ABSTRACT

The present disclosure and related inventions relate to a combination of gift wrapping paper and pre-cut pieces of adhesive tape. The gift wrap may be a single individual sheet that is wound around a tube or mandrel, otherwise known as roll wrap or it may be folded into neat, square or rectangular shapes, also known as flat wrap. Several pieces of pre-cut tape are provided on an adhesive backing sheet, from which the pre-cut tape can be easily removed. The tape may come in various shapes, sizes and colors. Alternatively, to/from stickers or adhesive seals may be provided in place of or in addition to the pre-cut strips of tape. The gift wrapping paper with tape is packaged together in shrink wrap, cellophane or other clear or transparent packaging material. The package may additionally include bows, ribbons, cards, scissors, gift wrap cutter or other gift wrap accessory.

### RELATED APPLICATIONS

This application claims priority to U.S. Provisional Patent Application Ser. No. 61/359,848, filed on Jun. 30, 2010, which is incorporated herein by reference in its entirety.

### FIELD OF THE INVENTION

The present invention is in the field of social expression products and more specifically to roll gift wrap and gift wrap accessories and supplies.

### BACKGROUND OF THE INVENTION

Gift wrapping typically requires at least one sheet of gift wrapping paper, a pair of scissors or gift wrap cutter and adhesive tape or other adhesive mechanism. The gift wrapping paper is wrapped around the gift or package and folded in a variety of ways so that the gift wrapping paper fits snuggly around the gift or package. The various folds must be secured in place and this is typically done by using several pieces of adhesive tape. Gift wrapping paper and tape are commonly sold in the same department of a retail store but are sold as separate pre-packaged items.

### SUMMARY OF THE INVENTION

The present disclosure and related inventions are in the field of paper gift wrapping products in sheet form, which can be wound around a mandrel, tube or other form, or neatly folded into square or rectangular shapes. Paper gift wrap is used to wrap gifts or other items to be concealed. More specifically, the invention relates to a sheet of gift wrapping paper that is wound around a single tube made of cardboard, or other suitable material and further including a sheet of removable adhesive strips and/or tags that can be used to secure the wrapping around the gift or package. The gift wrapping paper and the sheet of removable adhesive strips is further wrapped or encased in a clear material such as cellophane to be presented and sold as a single item.

### DESCRIPTION OF THE DRAWINGS

FIG. 1A is a front view of the gift wrap with tape of the present invention.

FIG. 1B is a perspective view of FIG. 1A.

FIG. 2 is a partial front view of FIG. 1A.

FIG. 3 is a front view of the front surface of a sheet of six individual sheets of adhesive tape strips.

FIG. 4 is a front view of the back surface of a single sheet of adhesive tape strips.

FIG. 5 is a front view of the front surface of a single sheet of to/from stickers.

### DETAILED DESCRIPTION OF PREFERRED AND ALTERNATE EMBODIMENTS

The present invention and related disclosure is in the field of paper gift wrapping products in sheet form, which can be wound around a mandrel, cylindrical tube or other form, that are used to wrap gifts or other items to be concealed. More specifically, the invention relates to a sheet of gift wrapping paper that is wound around a single tube made of cardboard, or other suitably strong material and further including a sheet of removable adhesive strips that can be used to secure the wrapping around the gift or package. The gift wrapping paper and the sheet of removable adhesive strips is further shrink wrapped or encased in a clear material such as cellophane to be presented and sold as a single item.

Adhesive tape is commonly used to attach gift wrapping paper to an enclosed gift or package. Typically, adhesive tape is sold as a separate item wherein one unitary piece of tape (approximately 200 inches in length) is continuously wound about a circular roll or core and placed within a plastic tape dispenser structure housing that provides a serrated edge to cut or release a portion of tape from the roll. Tape roll dispensers and gift wrap may or may not be sold in the same area of a retail department or store.

In order to efficiently wrap a gift or package, gift wrapping paper and adhesive tape must be readily available. The wrapping is typically folded about the package and secured thereto using one or more pieces of adhesive tape. It is important that the tape be conveniently located or near to the gift wrapping paper as one must hold the various folds in place until a piece of tape is cut and placed in the appropriate location to secure the paper around the gift or package. The process can be cumbersome as each time a fold must be secured, a new piece of tape must be unrolled and cut by the tape dispenser. Including tape with the gift wrap also makes it more convenient for the consumer by eliminating the need to search for and locate or purchase a roll of adhesive tape. Oftentimes a consumer is faced with purchasing a last minute gift or and having to wrap the gift while on the go or in the car on the way to a party or other event. Having the pre-cut tape strips included with the gift wrap facilitates this endeavor.

The gift wrap with tape combination of the present invention 100 includes a length of roll wrapping paper 10 which is wrapped about an elongate tube or mandrel (referred to interchangeably herein as “gift wrap”, “wrapping paper”, “roll wrap material” and “roll wrap”) which is, in a preferred embodiment, approximately 15 square feet in length or capable of wrapping three shirt boxes. Included with the roll wrap 10 is a substrate or backing 16 containing a plurality of pre-cut adhesive strips 14 (referred to herein interchangeably as “pre-cut adhesive strips”, “pre-cut tape strips”, “pre-cut tape”, “tape strips”, “adhesive strips”, or “adhesive tape strips”) attached thereto which may be easily peeled off and used as necessary. The tape 14 may be single or double-sided. It may contain various perforated lines to facilitate easy release of the tape from the substrate or backing In a preferred embodiment, the substrate or backing 16 is approximately 5.75 inches in length by 3.5 inches wide, containing approximately 20 pieces of pre-cut, single-sided tape 14. The number of tape strips 14 included may vary with the length of the roll wrapping material 10. In a preferred embodiment, the plurality of pre-cut adhesive strips 14 is uniform in length and width, such as, for example, approximately 1.3 inches long and 0.55 inches wide. In alternate embodiments, the tape strips 14 may be provided in various lengths and/or widths. While the pre-cut tape strips 14 are described and shown herein by example as being rectangular in shape, the tape strips 14 may alternatively be formed in a variety of shapes such as circular, square or any other geometrical form or shape. The individual pre-cut adhesive strips 14 may all be clear or transparent having no color, may all be of a single color, or may be of various colors. They may optionally include text printed thereon including phrases such as “no peeking” or may have a logo or other decorative indicia printed thereon or be color or design coordinated with the gift wrap material 10.

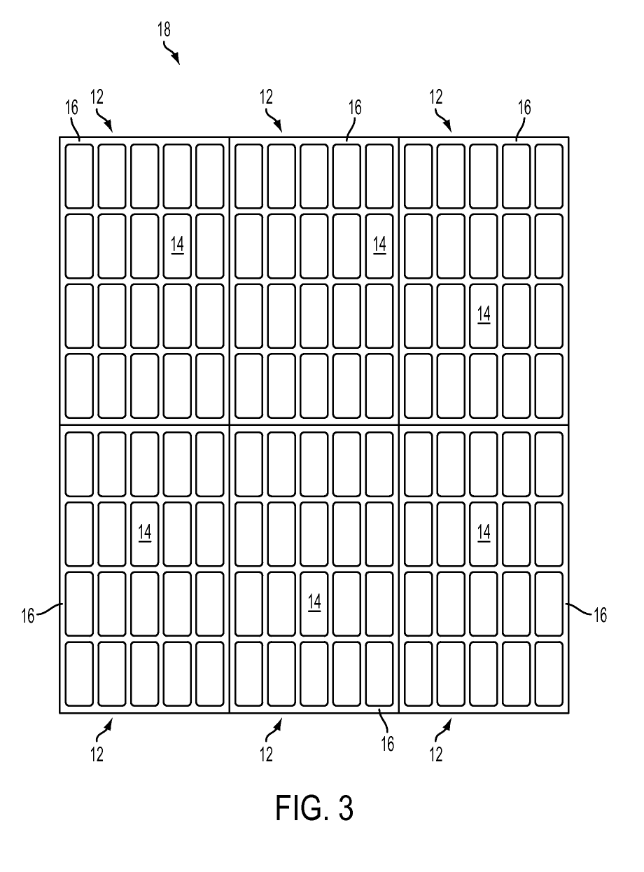

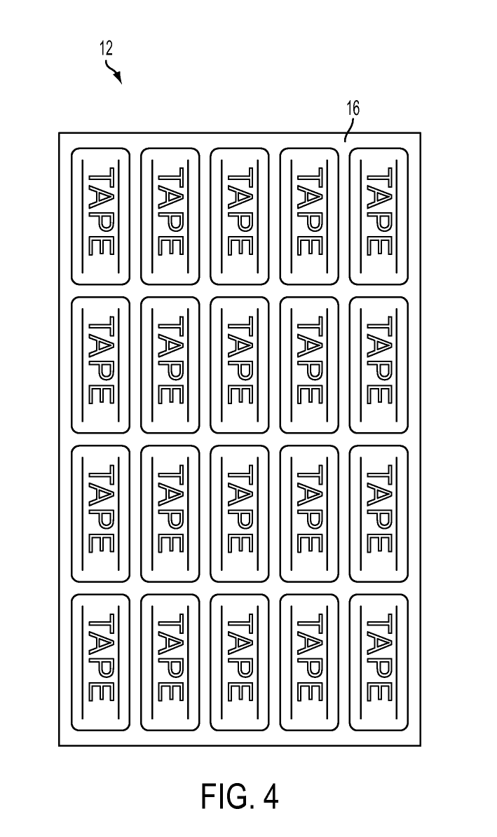

The substrate or backing 16 which contains the individual pieces of pre-cut tape 14 are, in a preferred embodiment, produced in sheets of six 18, shown in FIG. 3, which are approximately 10.5 inches wide by approximately 11.5 inches long. The sheet 18 is then cut into six individual sheets 12, each having approximately 20 individual pieces of pre-cut tape strips 14 attached thereon. As mentioned above, the number of individual pre-cut tape strips 14 is dependent on the size or length of the roll wrap material 10. The larger or longer the wrap material 10, the more strips 14 are included. The substrate or backing 16 may have the word “tape” printed on the back or surface of the substrate 16 opposite the pre-cut tape 14, as shown in FIG. 4, to indicate to the consumer that the pre-cut tape 14 is included within the package 100. The word “tape” may appear several times across and down the substrate 16 to indicate the number of tape strips 14 provided.

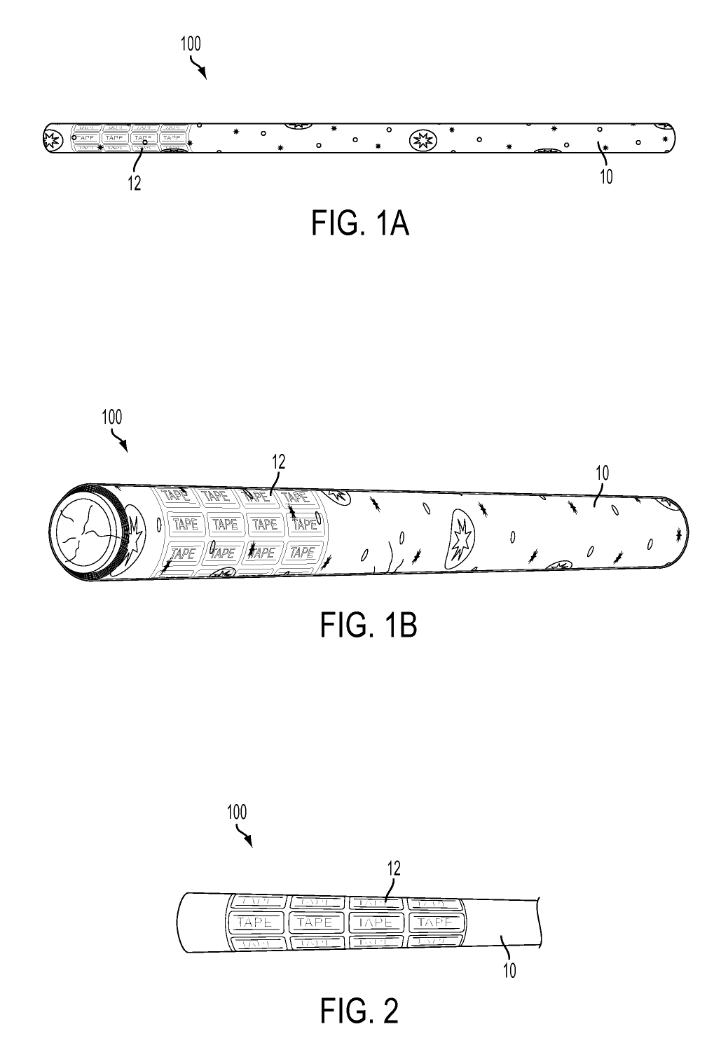

The packaging of the gift wrap/tape combination of the present invention 100 is the same as or similar to conventional packaging of gift wrap material in roll form. Typically roll wrap shrink-wrapped or otherwise packaged in a clear or transparent material, such as cellophane. The substrate or backing 16 containing the pre-cut adhesive strips 14 may be placed over the wrapping material 10 before the roll is shrink-wrapped or otherwise packaged, as shown in FIGS. 1A and 1B. The surface of the substrate 16 containing the actual tape strips 14 may be placed face down or directly facing the roll wrap material 10 in the packaging, such that the opposite surface containing the printing of the word “tape” is facing outward to be seen by consumers, as shown in FIG. 2. Alternatively, the substrate or backing 16 containing the pre-cut tape 14 may be placed inside the tube or roll form. In this case, alternate printing or packing on the product would indicate that pre-cut tape is included within the packaging. Phrases such as “Tape Included” or “Gift Wrap with Tape” may be clearly printed on the product packaging, regardless of how the tape is positioned within the packaging, to alert the consumer of the inclusion of the pre-cut tape 14. The packaging may contain one or multiple sheets of the substrate or backing 16 with pre-cut tape 14. Again, the number of tape strips 14 included within a package of roll wrap would directly depend on the amount or length of roll wrap 10 included in the packaging. The larger or longer the roll wrap material 10, the more pre-cut tape 14 is included.

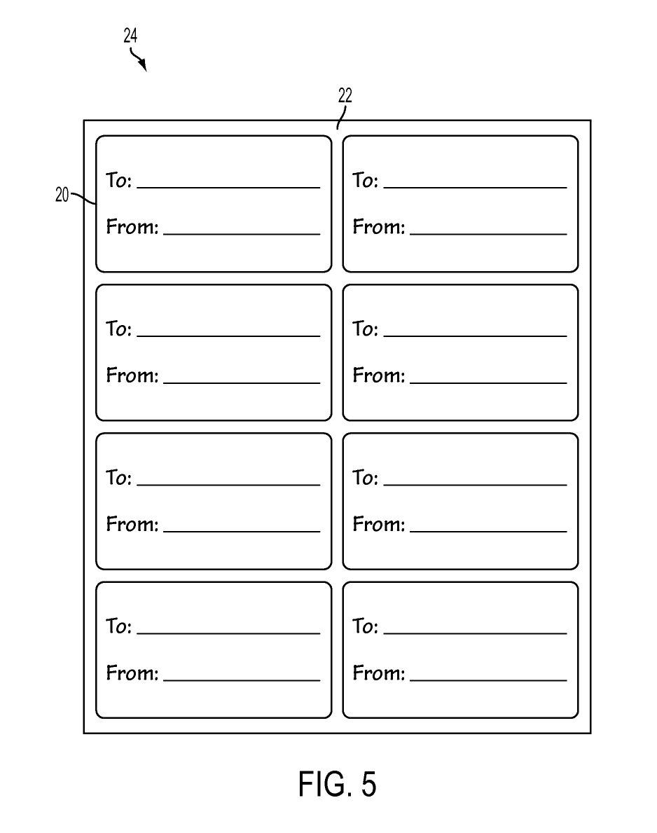

In an alternate embodiment, in addition to or in place of, the roll wrap material 10 may include a sheet of to/from tags 24. Each sheet 24 may include a substrate or backing 22 having a plurality of to/from tags 20, individual stickers or adhesive dots thereon. The to/from tags 20 and/or stickers, shown in FIG. 5, may be contained on a substrate or backing 22 being, for example, 4-inches long and 6-inches wide. These tags 20 and/or stickers may contain festive designs that correspond to a particular occasion such as a birthday or Christmas. As with the pre-cut tape, the tags 20 and/or stickers may be of various shapes and sizes.

In another embodiment, a plurality of non-adhesive cardstock to/from tags may be included with the roll wrap in a packaging method as described above with respect to the roll wrap/pre-cut tape embodiment. One piece of card stock may be scored or perforated to form a plurality of to/from tags. These tags may be in place of or in addition to the pre-cut adhesive strips and/or the adhesive to/from tags and/or stickers.

In yet another embodiment, the gift wrap/tape or gift wrap/tag combination package may further include a small card, ribbon, bow, scissors or other gift wrap accessory.

In still another embodiment, the gift wrap material may be folded into a square or rectangle and packaged and sold as flat wrap. The pre-cut adhesive strips or tags may be inserted on top of the flat wrap so it can easily be seen through the clear or transparent packaging material.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. A combination of gift wrap and adhesive tape comprising:
a single generally rectangular, planar sheet of gift wrap paper having a top edge, a bottom edge opposite the top edge, a printed side and a non-printed side;
a hollow, generally elongate tube; and
a substrate containing a plurality of pre-cut adhesive strips contained thereon,
wherein the gift wrap paper is wound around the tube with the printed side facing outward, the substrate is placed over the gift wrap paper wound around the tube and the entire tube with paper and substrate is encased in a transparent packaging material.

2. The combination of gift wrap and adhesive tape of claim 1, wherein the substrate contains approximately 20 separate pre-cut adhesive strips.

3. The combination of gift wrap and adhesive tape of claim 1 further comprising a second substrate containing a plurality of adhesive to/from tags.

4. The combination of gift wrap and adhesive tape of claim 1 further comprising a second substrate containing a plurality of scored non-adhesive to/from tags.

5. The combination of gift wrap and adhesive tape of claim 1 further comprising one sheet of perforated cardstock having a plurality of non-adhesive to/from tags.

6. The combination of gift wrap and adhesive tape of claim 1 further comprising a second substrate containing a plurality of decorative stickers contained thereon.

7. The combination of gift wrap and adhesive tape of claim 1, wherein the substrate contains various scored lines to facilitate easy removal of the pre-cut adhesive strips from the substrate.

8. The combination of gift wrap and adhesive tape of claim 1, wherein the word “tape” is printed on a surface of the substrate that is opposite the surface of the substrate containing the plurality of pre-cut adhesive strips.

9. The combination of gift wrap and adhesive tape of claim 1, wherein the word “tape” is printed on a surface of the substrate that is opposite the surface containing the plurality pre-cut adhesive strips, directly behind each of the plurality of pre-cut adhesive strips.

10. The combination of gift wrap and adhesive tape of claim 1, wherein the plurality of pre-cut adhesive strips are not of equal size.

11. A gift wrap and tape combination package comprising:
a sheet of gift wrap paper wound about a mandrel wherein a printed side of the gift wrap is facing outward;
a substrate having a plurality of pre-cut tape strips contained thereon,
the substrate and sheet of gift wrap paper shrink-wrapped together such that the printed side of the gift wrap and the substrate are visible through the shrink-wrap.

12. The gift wrap and tape combination package of claim 11, wherein the substrate contains approximately 20 pre-cut tape strips.

13. The gift wrap and tape combination package of claim 11, wherein the substrate contains a first side on which the plurality of pre-cut tape strips are contained, and a second side which is opposite the first side and which has the word “tape” printed thereon behind each of the plurality of pre-cut tape strips.

14. The gift wrap and tape combination package of claim 13, wherein the second side of the substrate is visible through the shrink wrap.

15. The gift wrap and tape combination package of claim 11, wherein the substrate contains a plurality of perforations to facilitate easy removal of the plurality of pre-cut tape strips from the substrate.

16. The gift wrap and tape combination package of claim 11, wherein the plurality of pre-cut tape strips are clear or transparent.

17. The gift wrap and tape combination package of claim 11 further comprising a second substrate containing a plurality of adhesive to/from tags contained thereon.

18. The gift wrap and tape combination package of claim 11 further comprising a second substrate containing a plurality of scored, non-adhesive to/from tags contained thereon.

19. The gift wrap and tape combination package of claim 11, wherein the plurality of pre-cut tape strips are of the same size.

20. The gift wrap and tape combination package of claim 11, wherein the plurality of pre-cut tape strips are of a variety of different sizes.

21. A combination of gift wrap and adhesive tape comprising:
one or more sheets of gift wrap paper folded into a generally rectangular configuration; and
a substrate containing a plurality of pre-cut adhesive strips contained thereon,
wherein the gift wrap paper and substrate are encased in a transparent packaging material and both the gift wrap paper and substrate can be seen through the packaging material.

22. The combination of gift wrap and adhesive tape of claim 21, wherein the substrate contains a first side on which the plurality of pre-cut tape strips are contained, and a second side which is opposite the first side and which has the word “tape” printed thereon behind each of the plurality of pre-cut tape strips.

23. The combination of gift wrap and adhesive tape of claim 22, wherein the second side of the substrate is visible through the packaging material.

24. The combination of gift wrap and adhesive tape of claim 21, wherein the substrate contains approximately 20 pre-cut tape strips.
